(19) United States
(12) Patent Application Publication
(10) Pub. No.: US 2008/0304107 A1
(43) Pub. Date: Dec. 11, 2008

(54) INFORMATION PROCESSING APPARATUS, INFORMATION PROCESSING METHOD, COMPUTER PROGRAM, AND IMAGE FORMING SYSTEM

(75) Inventor: Junichi Yamakawa, Hiratsuka-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/136,754

(22) Filed: Jun. 10, 2008

(30) Foreign Application Priority Data
Jun. 11, 2007 (JP) 2007-154437

(51) Int. Cl. G06F 15/00; G06K 15/00

(52) U.S. Cl. 358/1.18; 358/1.9

(57) ABSTRACT

An information processing apparatus includes a layout unit which lays out content data contained in record data, a specifying unit which specifies items of a database to which each content data laid out in the form data, a layout data generation unit which generates layout data associated with the layout of content data so as to lay out, at the position of content data of laid-out record data, content data of another record data belonging to the same item as that of the content data of the laid-out record data, a variable data generation unit which generates variable data for rendering the content data of the other record data in the form data based on the layout data, and a transmission unit which transmits a print job containing the form data and variable data to the image forming apparatus.

### BACKGROUND OF THE INVENTION

1. Field of the Invention

The present invention relates to an information processing technique and image forming technique.

2. Description of the Related Art

A method of printing from application software on a computer via a printer driver has been conventionally used. A method of printing by directly transmitting a file of a predetermined format such as PostScript to a printer using software called a downloader is also popular.

One-to-one marketing which satisfies customer needs receives attention, and variable printing capable of providing individually customized printed materials also attracts attention. However, the variable printing system generally has many functions, is expensive, and requires a dedicated application which cooperates with a database.

Some image processing apparatuses can use, as an input file, data described in the PPML language (Personalized Print Markup Language) which is a print language specialized in variable printing. The image processing apparatus prints by applying a form print function to variable printing without sending or rasterizing permanent data again. A technique associated with this method is disclosed in, for example, Japanese Patent Laid-Open No. 2006-264224.

However, to generate data described in the PPML language in conventional variable printing, a system needs to be established from an expensive dedicated application and database.

It is difficult to execute printing with a complicated layout when CSV data output from a database and the merging function of word-processing software or the like are used without using a dedicated application. The user may not be able to obtain a variable printing result he wants.

### SUMMARY OF THE INVENTION

The present invention has been made to overcome the conventional drawbacks, and has as its object to allow the user to obtain a variable printing result he wants without the mediacy of a variable printing-specific application.

According to one aspect of the present invention, there is provided an information processing apparatus capable of communicating with an image forming apparatus capable of form overlay printing, the information processing apparatus comprising: a layout unit adapted to lay out content data contained in record data in form data used in the form overlay printing; a specifying-unit adapted to specify an item of a database to which each content data laid out in the form data by the layout unit belongs; a layout data generation unit adapted to generate layout data associated with layout of content data so as to lay out, at a position of content data of laid-out record data, content data of another record data belonging to the same item as an item of the content data of the laid-out record data by using a specified result of the specifying unit; a variable data generation unit adapted to generate variable data for rendering the content data of the another record data in the form data on the basis of the layout data; and a transmission unit adapted to transmit a print job containing the form data and the variable data to the image forming apparatus.

According to another aspect of the present invention, there is provided an information processing method in an information processing apparatus capable of communicating with an image forming apparatus capable of form overlay printing, the method comprising: a layout step of causing a layout unit to lay out content data contained in record data in form data used in the form overlay printing; a specifying step of causing a specifying unit to specify an item of a database to which each content data laid out in the form data in the layout step belongs; a layout data generation step of causing a layout data generation unit to generate layout data associated with layout of content data so as to lay out, at a position of content data of laid-out record data, content data of another record data belonging to the same item as an item of the content data of the laid-out record data by using a specified result of the specifying step; a variable data generation step of causing a variable data generation unit to generate variable data for rendering the content data of the another record data in the form data on the basis of the layout data; and a transmission step of causing a transmission unit to transmit a print job containing the form data and the variable data to the image forming apparatus.

According to still another aspect of the present invention, there is provided a computer program which is stored in a storage medium readable by an information processing apparatus and causes an information processing apparatus capable of communicating with an image forming apparatus capable of form overlay printing to execute an information processing method, the information processing method comprising: a layout step of causing a layout unit to lay out content data contained in record data in form data used in the form overlay printing; a specifying step of causing a specifying unit to specify an item of a database to which each content data laid out in the form data in the layout step belongs; a layout data generation step of causing a layout data generation unit to generate layout data associated with layout of content data so as to lay out, at a position of content data of laid-out record data, content data of another record data belonging to the same item as an item of the content data of the laid-out record data by using a specified result of the specifying step; a variable data generation step of causing a variable data generation unit to generate variable data for rendering the content data of the another record data in the form data on the basis of the layout data; and a transmission step of causing a transmission unit to transmit a print job containing the form data and the variable data to the image forming apparatus.

According to yet another aspect of the present invention, there is provided an image forming system comprising an information processing apparatus capable of generating a print job interpretable by an image forming apparatus, and an image forming apparatus capable of form overlay printing on the basis of the print job, the information processing apparatus comprising: a layout unit adapted to lay out content data contained in record data in form data used in the form overlay printing; a specifying unit adapted to specify an item of a database to which each content data laid out in the form data by the layout unit belongs; a layout data generation unit adapted to generate layout data associated with layout of content data so as to lay out, at a position of content data of laid-out record data, content data of another record data belonging to the same item as an item of the content data of the laid-out record data by using a specified result of the specifying unit; a variable data generation unit adapted to generate variable data for rendering the content data of the another record data in the form data on the basis of the layout data; and a transmission unit adapted to transmit a print job containing the form data and the variable data to the image forming apparatus, and the image forming apparatus comprising: a reception unit adapted to receive the form data and the variable data which are transmitted from the information processing apparatus; a job data control unit adapted to register the form data; a composition unit adapted to composite the variable data and the form data; and an image forming unit adapted to execute image forming processing on the basis of the form data and the variable data which are composited by the composition unit.

According to the present invention, variable printing can be executed without the mediacy of a variable printing-specific application.

Further features of the present invention will become apparent from the following description of exemplary embodiments (with reference to the attached drawings).

### BRIEF DESCRIPTION OF THE DRAWINGS

FIG. 1 is a view showing the configuration of an image forming system according to an embodiment;

FIG. 2 is a block diagram of a controller incorporated in an image forming apparatus;

FIG. 3 is a view for explaining variable printing;

FIG. 4 is a flowchart for explaining the sequence of creating master data and layout-added master data in a client computer;

FIG. 5 is a view exemplifying master data;

FIG. 6 is a view exemplifying layout-added master data;

FIG. 7 is a table exemplifying the top part of spreadsheet data (tabular data) read out from record data or a database;

FIG. 8 is a block diagram showing a functional configuration for executing print processing as the attribute of processing corresponding to a hot folder;

FIG. 9 is a flowchart for explaining the sequence of variable print processing in the hot folder;

FIG. 10 is a flowchart for explaining the sequence of layout data generation processing;

FIG. 11 is a view exemplifying part of layout data;

FIG. 12 is a view exemplifying the first three pages of variable data;

FIG. 13 is a flowchart for explaining the sequence of variable print processing in the image forming apparatus;

FIG. 14 is a view showing the variable print setting window of a hot folder manager;

FIG. 15 is a flowchart for explaining the sequence of determination processing for determining whether a compressed record-added master can undergo variable printing; and

FIG. 16 is a block diagram of the hardware configuration of an information processing apparatus.

### DESCRIPTION OF THE EMBODIMENTS

Preferred embodiments of the present invention will be exemplified in detail below with reference to the accompanying drawings. Components set forth in these embodiments are merely examples. The technical scope of the present invention should be determined by the appended claims and is not limited to the individual embodiments to be described below.

### First Embodiment

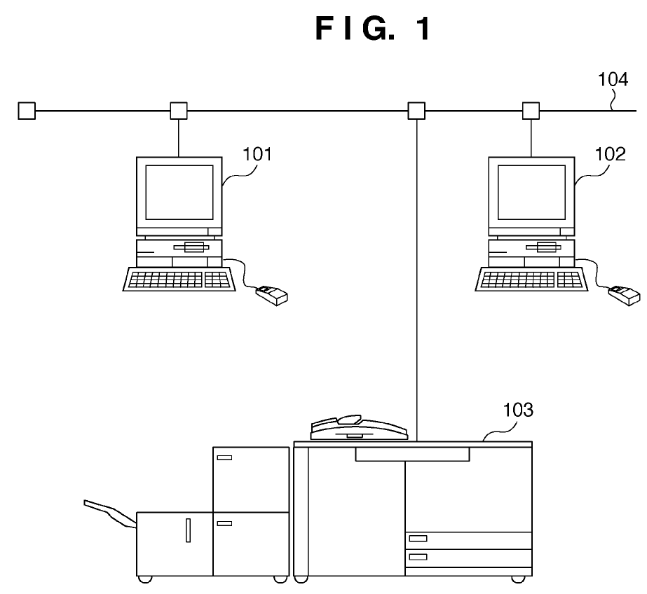

FIG. 1 is a view showing the configuration of a basic image forming system according to the first embodiment. A client computer (information processing apparatus) 101 has a hot folder. When data is input to the hot folder (storage area), the CPU of the client computer 101 can generate a print job to which the attribute of processing corresponding to the hot folder is applied. The user can operate the hot folder on the client computer 101 to generate a print job.

It is also possible to configure software capable of, when data is input to a storage area called a hot folder in a computer, processing the data by applying the attribute of processing corresponding to the hot folder. A method of monitoring a hot folder by software, and when a new file or data is input to the hot folder, downloading the new file or data to a printer is also available. Print setting information including selection of image processing and sort selection in printing can be set for each hot folder. Some PostScript printers have a function capable of directly printing PDF files widely used in the Internet, in addition to PostScript files. The hot folder receives attention as a method capable of easily printing without using an application or printer driver.

The hot folder is basically the same as a folder provided by an operating system (OS), and can also be shared by file sharing via a network. By setting an image forming apparatus for a hot folder, the information processing apparatus 101 can transmit data to the image forming apparatus when the data is input to the hot folder. A print job transmitted to the image forming apparatus is data interpretable by the image forming apparatus.

The client computer 101 can communicate with a server computer 102 and image forming apparatus 103 via a network 104.

The server computer 102 is used as a database server and shared file server. The image forming apparatus 103 is a multifunctional peripheral which is also available as a digital printing press. The image forming apparatus 103 is connected to a scanner and finisher, and can scan and copy an image and cause the finisher to perform post-processing for the printing result.

The image forming apparatus 103 can also transmit an image scanned by the scanner to another apparatus, execute a print job sent from the client computer 101, and process print data.

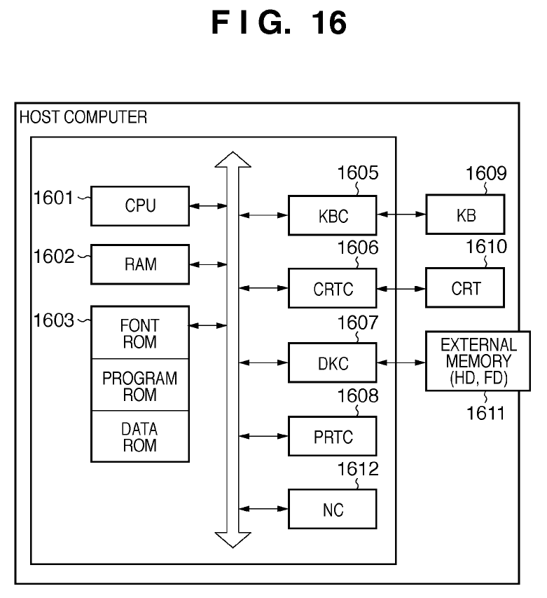

FIG. 16 is a block diagram of the hardware of the client computer 101 (information processing apparatus). In FIG. 16, a CPU 1601 executes programs such as an OS, general application, and bookbinding application stored in the program ROM of a ROM 1603 or loaded from a hard disk 1611 to a RAM 1602. The CPU 1601 implements the software configuration in FIG. 1 and the sequences of flowcharts (to be described later). The RAM 1602 functions as a main memory, work area, and the like for the CPU 1601. A keyboard controller (KBC) 1605 controls key inputs from a keyboard 1609 and a pointing device (not shown). A CRT controller (CRTC) 1606 controls display on a CRT display 1610. A disk controller (DKC) 1607 controls access to a boot program, various applications, font data, user files, the hard disk (HD) 1611, a floppy® disk (FD), and the like. A PRTC 1608 controls exchange of signals with a connected printer 107. An NC 1612 is connected to a network and executes communication control processing with another device connected to the network.

(Arrangement of Controller 2000)

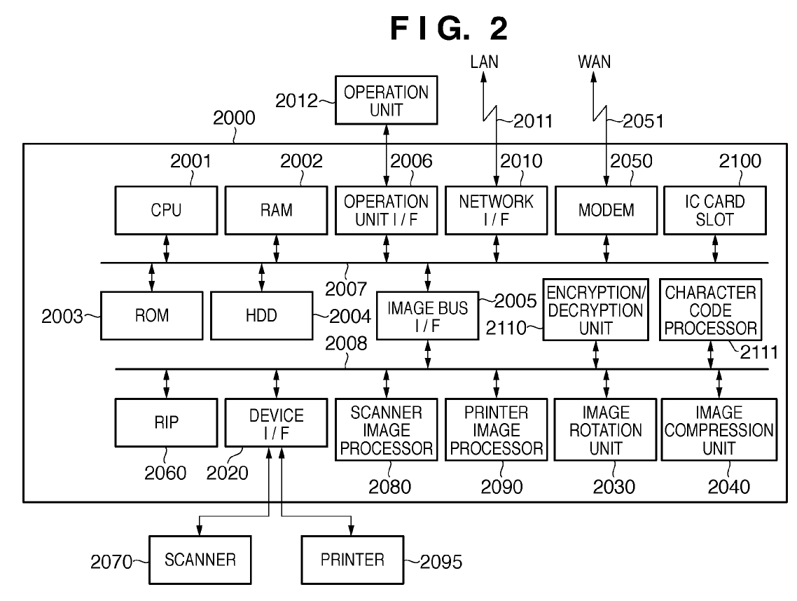

FIG. 2 is a block diagram of a controller 2000 incorporated in the image forming apparatus 103. The controller 2000 is connected to a scanner 2070 serving as an image input device, and a printer 2095 serving as an image output device.

The controller 2000 can input/output image information and device information via a LAN 2011 and public communication line (WAN) 2051.

A CPU 2001 can control the overall image forming apparatus 103. A RAM 2002 can function as a work area required to operate the CPU 2001, and is also an image memory used to temporarily store image data.

A ROM 2003 is a boot ROM which stores the boot program of the image forming apparatus 103. An HDD 2004 is a hard disk drive which can store system software and image data.

An operation unit interface (I/F) 2006 is an interface with an operation unit (UI) 2012 having a touch panel, and can output image data to be displayed on the operation unit 2012 to it. Also, the operation unit interface 2006 can transfer information input by the user via the operation unit 2012 to the CPU 2001.

A network interface (Network I/F) 2010 is connected to the LAN 2011 to input and output information. A modem 2050 is connected to the public communication line 2051 to input and output information.

An IC card slot 2100 performs user authentication based on an IC card medium. By the user authentication, the CPU 2001 can specify a user when executing a job. By inputting a proper PIN (Personal Identifier Number) code after inserting an IC card medium, a key used for encryption and decryption can be input/output. These devices are connected to a system bus 2007.

An image bus I/F 2005 is a bus bridge which connects the system bus 2007 and an image bus 2008 capable of transferring image data at high speed, and converts the data structure. The image bus 2008 is, for example, a PCI bus or IEEE1394.

The following devices are connected to the image bus 2008. A raster image processor (RIP) 2060 rasterizes a PDL code into a bitmap image. A device I/F 2020 connects the controller 2000 to the scanner 2070 and printer 2095 serving as image input and output devices, and performs image data conversion between a synchronous system and an asynchronous system.

A scanner image processor 2080 can correct, manipulate, and edit input image data. A printer image processor 2090 can perform correction, resolution conversion, and the like for the printer in accordance with printout image data. An image rotation unit 2030 can rotate image data.

An image compression unit 2040 can compress/decompress multi-valued image data by JPEG, and binary image data by JBIG, MMR, MH, or the like. An encryption/decryption unit 2110 is a hardware accelerator board which encrypts/decrypts data using the key of the IC card slot 2100 or a device-specific key. A character code processor 2111 interprets character information or a two-dimensional barcode contained in image data and converts it into a character code.

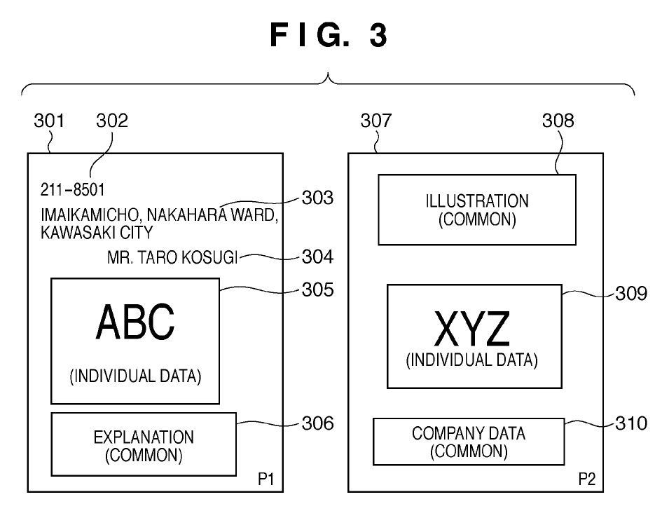

FIG. 3 is a view for explaining variable printing. Data for executing variable printing includes variable data and master data. In variable printing, data (also called content data) of respective customers registered in the database are repetitively printed for each record, like direct mail.

Permanent data which does not change upon switching the record is called master data, and data which changes for each record is called variable data.

(Description of Master Data and Variable Data)

FIG. 3 shows an example of variable printing in which data of one record are arranged on two pages. Background data 301 defines the layout of the first page and is master data because it is used for all records.

A postal code 302, address 303, and name 304 are data which change for each record, and are content data contained in variable data. Individual data 305 changes depending on the contents of variable data, and is data (e.g., data for men, women, or 60 or more years old) which changes depending on content data of a predetermined item in the record. The individual data 305 is also variable data because it is not used for all records.

Common data 306 is master data because it is an explanation commonly used for all records.

Background data 307 defines the layout of the second page and is master data because it is used for all records. An illustration 308 is commonly used for records and is master data commonly used for all records. Variable data 309 can change for each record, similar to the individual data 305. Permanent data 310 is, for example, the address of a company and is common to all records.

(Sequence of Creating Master Data and Layout-Added Master Data)

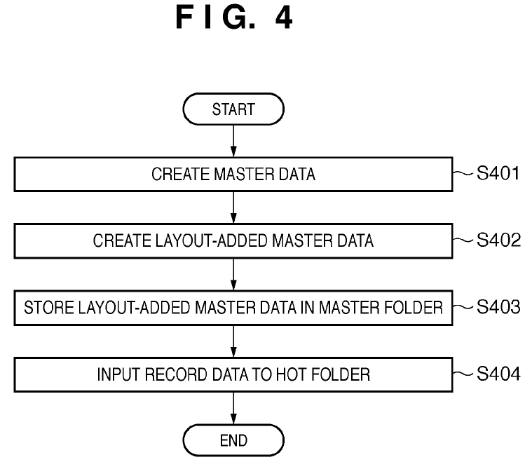

FIG. 4 is a flowchart for explaining the sequence of creating master data and layout-added master data in the client computer 101. This processing is executable under the control of the CPU in the client computer 101.

In S401, the CPU 1601 of the client computer 101 creates reference document data (master data) of a PDF file or the like in accordance with a user instruction. In S402, the CPU 1601 adds, to the master data, layout designation information created using specific data read out from record data. The specific data is, for example, the first data (first record) among the record data. Data obtained by adding, to master data, layout designation information created using specific record data is defined as layout-added master data.

In S403, the CPU 1601 stores the layout-added master data in a predetermined “master folder” in the hot folder in accordance with a user instruction.

The master folder is a storage area in the hot folder. As the data format, even layout-added master data can be printed. Thus, if layout-added master data is directly stored in the hot folder, processing set in the hot folder starts. To prevent this, according to the present invention, when layout-added master data is saved in the master folder, it is temporarily held in the master folder without transmitting it to the image forming apparatus.

In S404, record data is input to the hot folder, and the CPU 1601 starts variable print processing under the control of the hot folder manager. Whether input data is record data can be determined from the identifier of data stored in the folder. For example, if stored data has an identifier such as “.xls” or “.csv” representing a list, it is determined that the stored data is record data. It is also possible to determine that the stored data is record data when the CPU 1601 detects that information representing record data is added.

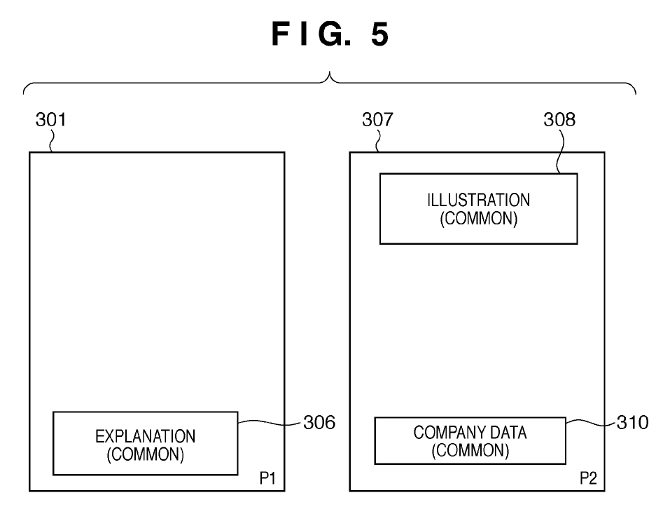

FIG. 5 is a view exemplifying master data (permanent data) shown in FIG. 3. In variable printing according to the first embodiment, master data is transmitted to the image forming apparatus 103 only once. The image forming apparatus 103 can use the master data as common data. Since no master data is transmitted to the image forming apparatus 103 for each record, the printing efficiency can improve. The master data is exploited as form data in overlay printing.

(Layout-Added Master Data)

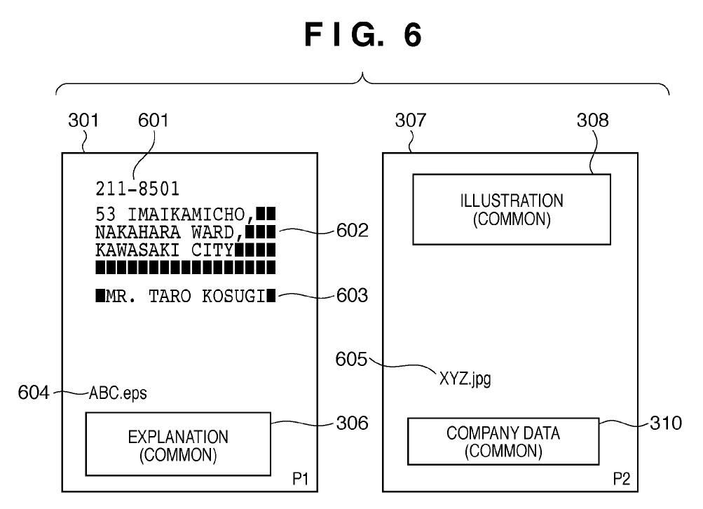

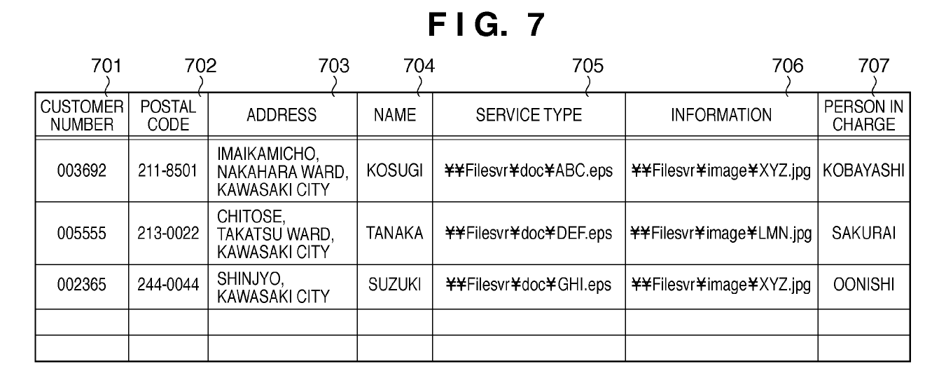

Details of layout-added master data will be described in detail with reference to FIGS. 6 and 7. FIG. 6 is a view exemplifying layout-added master data generated by adding layout designation information to the master data shown in FIG. 5. Layout designation information is generated under the control of the CPU of the client computer 101, and layout-added master data is generated by adding the layout designation information to master data. In FIG. 6, reference numeral 601 denotes postal code data; and 602, address data containing layout designation information. Reference numeral 603 denotes name data containing layout designation information; 604, an EPS file name; and 605, an image file name (XYZ.jpg).

FIG. 7 is a table exemplifying the top part of spreadsheet data (tabular data) read out from record data or a database.

Reference numerals 701 to 707 denote data fields in record data or a database. Reference numeral 701 denotes a customer number; 702, a postal code; 703, an address; and 704, a name. Reference numeral 705 denotes a service type which stores, as data, link information to a data file. Reference numeral 706 denotes information which stores link information to image data. Reference numeral 707 denotes data of the name of a person in charge. Available databases are a CSV (Comma Separated Values) file exported from a relational database, and a spreadsheet file such as an Excel file.

Object data can be designated by, for example, URL (http://imagesvr.xxx.com/share/abc.eps). Object data can also be designated by the use (YYimagesvrYshareYabc.eps) of a file sharing protocol (SMB (Server Message Block)). An object can be further designated by the designation (image/xyz.jpg) of a relative layer from a master folder.

Layout-added master data is generated by adding, to master data, layout designation information obtained using specific data (e.g., data of the first record) of information read out from record data or a database. Data which can be laid out are character data and object data.

(Case of Character Data)

Character data can be input by two methods, that is, by directly inputting characters or by using a comment input function with a text box. According to the method of directly inputting characters, data of the first record is directly described on master data by using word-processing software or the like. The displays (displays “▪” in FIG. 6) of predetermined spacers are inserted (arranged) as the input range. For example, spacer displays (“▪”) are inserted in the address data 602 and name data 603 shown in FIG. 6. The layouts of the address data 602 and name data 603, and the relative layout of the address data 602 and name data 603 can be controlled by layout designation information.

According to the other method, data of the first record is input to the text box comment field by text box comment input. In this case, the size of the text box represents the input range.

(Case of Object Data)

Examples of object data are a PS (PostScript) file object file such as EPS (Encapsulated PostScript), and an image object such as JPEG, BMP, or GIF. The following three input methods are proposed.

An object file name input method is to directly describe the object file name of the first record on master data. In this case, the lower left of an input character serves as the reference position of object insertion.

Note comment input is a method of inputting an object file name to the note comment field, and a referring position can be set as a reference position. The size of an object file can also be designated by numerical information following the object file name. Text box comment input is a method of inputting data of the first record to the text box comment field. The size of a text box represents the object input area, and an object larger than the input area is reduced to the input area.

(Functional Configuration for Executing Print Processing Using Hot Folder)

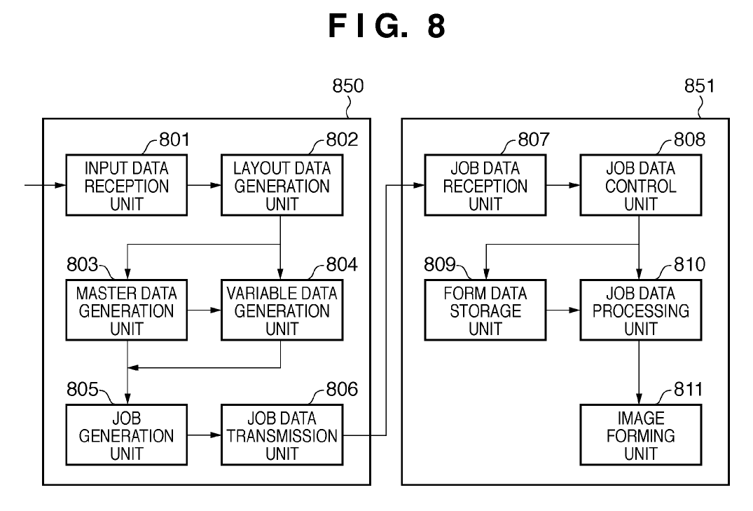

FIG. 8 is a block diagram showing a functional configuration for generating a print job to which the attribute of processing corresponding to a hot folder is applied, and executing the print job. Reference numeral 850 denotes an arrangement of a hot folder manager serving as a hot folder application in the client computer 101. The hot folder manager comprises functions 801 to 806. The input data reception unit 801 can determine the attribute of a print job input to the hot folder under the control of the hot folder manager. When it is determined that data input to the hot folder is record data, the hot folder manager starts variable print processing. Processing to determine whether data input to the hot folder is record data has been explained, and a description thereof will be omitted.

The layout data generation unit 802 generates layout data. The layout data designates to lay out, at the position of laid-out content data, content data of another record belonging to the same item as the laid-out content data. The master data generation unit 803 generates master data from layout-added master data stored in the master folder. The variable data generation unit 804 generates variable data from record data and layout-added master data. The job generation unit 805 generates a print job from master data and variable data. The job data transmission unit 806 transmits a print job containing master data and variable data to the image forming apparatus 103 serving as a multifunctional peripheral having the printer function, scanner function, and the like. The job data transmission unit 806 transmits master data as master data-registered print setting data which inhibits the use of the master data by another print job. The job data transmission unit 806 transmits variable data to the image forming apparatus 103 as a form print setting using master data as a form.

Reference numeral 851 denotes a functional arrangement in the image forming apparatus 103. A job data reception unit 807 receives a variable data print job which is transmitted from the job data transmission unit 806 and contains master data and variable data. A job data control unit 808 controls execution of a print job in the image forming apparatus 103. At this time, master data has a master-registered print setting of inhibiting the use of master data by another print job, unlike general form printing. Thus, no master data can be used by another print job.

The job data control unit 808 stores master data in a form data storage unit 809. A job data processing unit 810 processes image data generated by compositing variable data and master data controlled by the job data control unit 808. An image forming unit 811 executes image forming processing based on image data processed by the job data processing unit 810.

(Sequence of Variable Print Processing in Hot Folder)

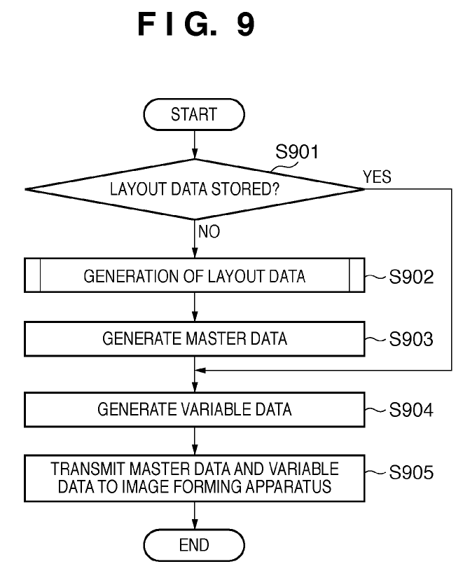

FIG. 9 is a flowchart for explaining the sequence of variable print processing in the hot folder. This processing is executable under overall control of the hot folder manager. When data is input to the hot folder, the input data reception unit 801 of the hot folder manager detects the input of the data, and analyzes the attribute (file type) of the data. If the input data reception unit 801 determines that the data input to the hot folder is data of the record format (record data), the hot folder manager starts variable print processing. Determination of whether input data is data of the record format has been explained, and a description thereof will be omitted.

Data of the record format (record data) is data which is stored for each subject on one line (record) including a plurality of columns (fields).

In S901, the hot folder manager determines whether the master folder in the hot folder stores layout data. If the master folder stores layout data (YES in S901), the process advances to S904. If the master folder does not store layout data (NO in S901), the process advances to S902, and the hot folder manager generates layout data.

(Layout Data Generation Processing)

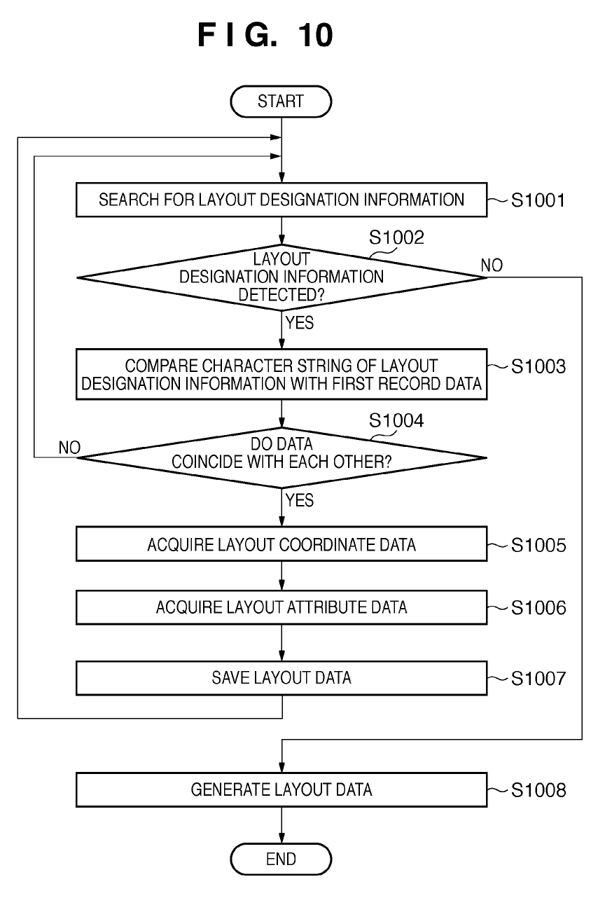

FIG. 10 is a flowchart for explaining the sequence of layout data generation processing executed in S902 of FIG. 9. The layout data generation unit 802 can execute this processing under the control of the hot folder manager.

In S1001, the layout data generation unit 802 of the hot folder manager searches for layout designation information (information on the character, text box comment, and note comment) contained in layout-added master data (document data).

If the layout data generation unit 802 determines in S1002 that no layout designation information is detected (NO in S1002), it advances the process to step S1008. If there is data temporarily saved in the master folder, the layout data generation unit 802 generates the data as layout data, and ends the process. If the layout data generation unit 802 of the hot folder manager detects layout designation information (YES in S1002), it advances the process to S1003.

In S1003, the layout data generation unit 802 compares a character string (character information) contained in the layout designation information with the first record data of the record data input to the hot folder. A concrete example of the process in S1003 will be explained. A character string “211-8501” is described in layout-added master data in FIG. 6. The layout data generation unit 802 compares “211-8501” of the layout-added master data with the postal code “211-8501” of record 1 in FIG. 7. This process corresponds to the process in S1003.

If the layout data generation unit 802 determines in S1004 that the character string (character information) as content data contained in the layout designation information does not coincide with the first record data (NO in S1004), it returns the process to S1001 to search for layout designation information again. If the layout data generation unit 802 determines that the character string (character information) contained in the layout designation information coincides with the first record data (YES in S1004), it advances the process to S1005. That is, if it is determined in S1004 that the content data coincides with the first record data, the item to which the laid-out content data belongs can be specified. By using the specified result, variable data can also be created for another record. More specifically, it is specified that “211-8501” in FIG. 6 belongs to “postal code” in FIG. 7. By using the specified result, the hot folder manager lays out the values of the postal code (same item) of record 2 and subsequent records at the position of “211-8501” in FIG. 6.

In S1005, the layout data generation unit 802 of the hot folder manager acquires position information (layout coordinate data) of the layout designation information.

When the layout designation information targets character data, the layout area can be determined by counting spacers (e.g., “▪” in FIG. 6). When the layout designation information represents the text box comment field setting, the position and size of a text box can be acquired to determine the position and size of the layout area. When the layout designation information represents the note comment field setting and numerical information is input immediately after record data, the size of the layout area can be determined based on the input numerical information, and the position of the layout area can be determined from the position of the note comment field.

In S1006, the layout data generation unit 802 acquires, as attribute data, attribute information such as the font type and font size of the layout designation information. More specifically, the layout data generation unit 802 may specify font designation information by analyzing an actually input character in FIG. 6, or specify it based on text box setting information.

Based on position information and attribute information, the hot folder manager can generate layout data for laying out field data (objects) of record data in the form (master data).

In S1007, the layout data generation unit 802 of the hot folder manager temporarily saves the layout data, and returns the process to S1001 to repeat the same process for another layout designation information.

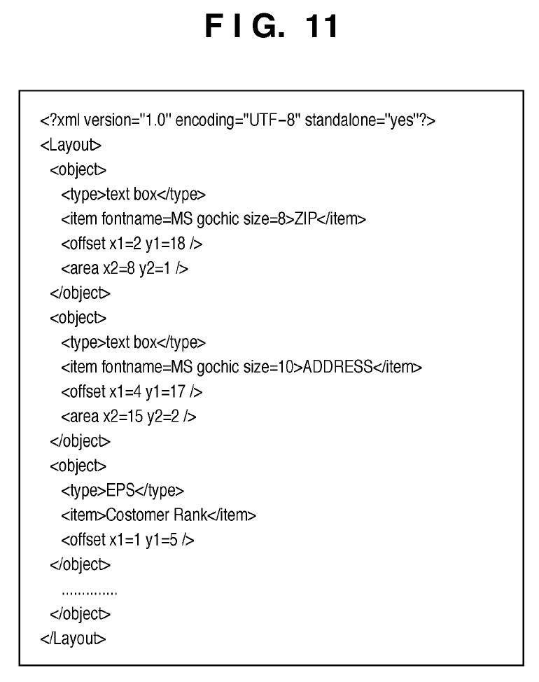

The layout data generated in S1001 to S1008 is saved in the master folder. FIG. 11 is a view exemplifying part of layout data. The layout data is XML data rooted at the <Layout> element. An object (<object>) element is defined for each variable data arranged in a variable area which is defined in the form and changes in accordance with the size and attribute of laid-out data and the like. As child elements of the object (<object>) element, the coordinate offset, object type, rendering area, font information, and the like can be defined.

By executing the processing in FIG. 10, the layout data generation unit 802 generates layout data which defines a position where data of each item of the database should be laid out, font information, and the like.

Referring back to FIG. 9, in S903, the master data generation unit 803 deletes the layout designation information (corresponding to 601 to 605 in FIG. 6) from the layout-added master data stored in the master folder. By deleting the layout designation information, the master data generation unit 803 generates master data as form data (common data) used in form overlay printing.

In S904, the variable data generation unit 804 generates variable data to be rendered in the form used in form overlay printing for each record data by using the layout data.

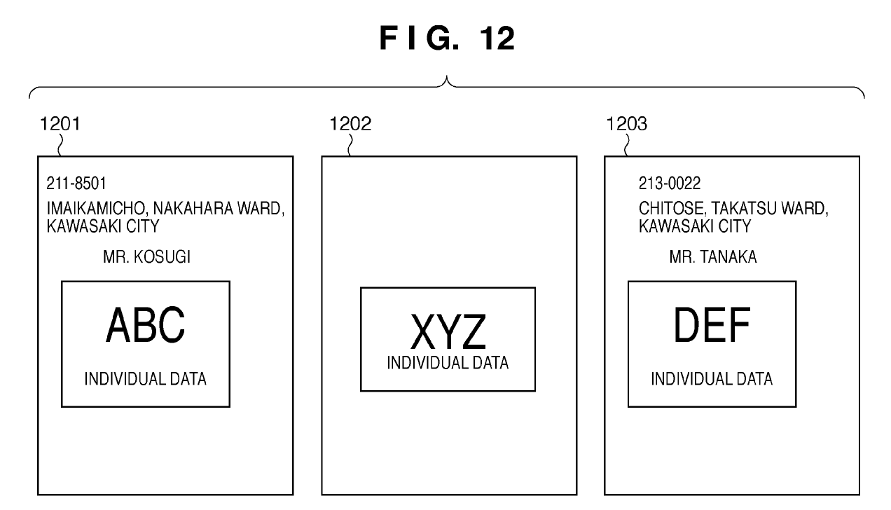

FIG. 12 is a view exemplifying the first three pages of variable data. Reference numeral 1201 denotes a first page of the first record; 1202, a second page of the first record; and 1203, a first page of the second record. The variable data generation unit 804 can generate variable data for laying out each record data in the form used in form overlay printing in accordance with, for example, the description of layout data in FIG. 11. Generation of variable data as shown in FIG. 12 is executed for all record data of document data. A concrete example of the variable data generation method will be explained. By the processing in FIG. 10, it is designated to lay out data “postal code” in FIG. 7 at a position (5,5) on the first page, data “address” at a position (5,10) on the first page, and data “name” at a position (15,15) on the first page. It is also designated to lay out data “service type” in FIG. 7 at a position (3,20) on the first page, and data “information” at a position (3,20) on the second page. Note that the values representing positions are coordinate values. The first numerical value in parentheses represents a horizontal position, and the second numerical value in the parentheses represents a vertical position when the upper left of the page is defined as the origin. Variable data as shown in FIG. 12 is generated as a result of laying out each data of record 1 in FIG. 7 in accordance with the layout data.

The job generation unit 805 generates a print job from master data and variable data. In S905, the job data transmission unit 806 of the hot folder manager transmits the print job containing the master data and variable data to the image forming apparatus 103. At this time, the job data transmission unit 806 transmits the master data as master data-registered print setting data to the image forming apparatus 103. The job data transmission unit 806 transmits the variable data as a form print setting using the master data as a form to the image forming apparatus 103.

If it is determined in S901 that there is layout data (YES in S901), master data has already been generated and transmitted to the image forming apparatus 103. Thus, the job data transmission unit 806 transmits only newly created variable data to the image forming apparatus 103 (S905).

(Sequence of Variable Print Processing in Image Forming Apparatus)

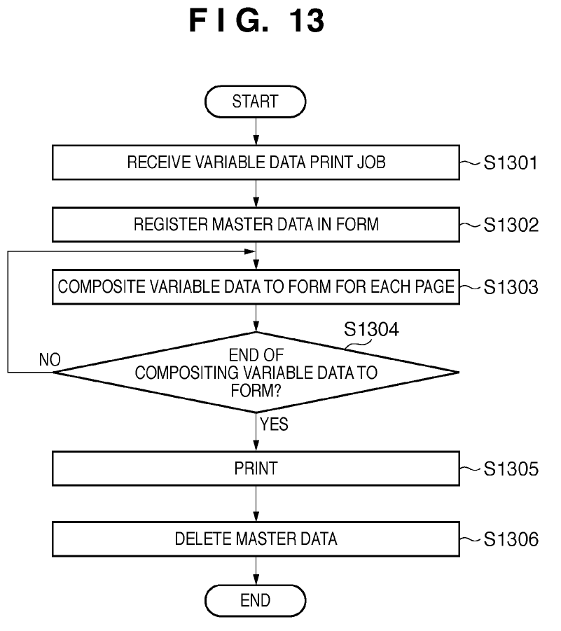

FIG. 13 is a flowchart for explaining the sequence of variable print processing in the image forming apparatus. In S1301, the job data reception unit 807 of the image forming apparatus 103 receives a variable data print job containing master data and variable data. When master data has already been generated and registered in the image forming apparatus 103, the job data transmission unit 806 transmits only newly created variable data to the image forming apparatus 103. In this case, the job data reception unit 807 receives only the variable data transmitted from the job data transmission unit 806.

In S1302, the job data control unit 808 of the image forming apparatus 103 registers (stores) the master data in the form data storage unit 809 as a form used in form overlay printing. At this time, the master data has the master-registered print setting, thus is stored in an area ensured for master data, and cannot be used by another print job, unlike general form printing.

In S1303, the job data processing unit 810 of the image forming apparatus 103 performs form composition processing to composite variable data and master data for each page. More specifically, for example, the same identification number is set for variable data and master data, and the job data processing unit 810 can use the identification number to specify master data in which variable data is to be laid out. The position of variable data in master data serving as a form is determined in accordance with record data. The job data processing unit 810 can achieve overlay printing by simply overlaying variable data and master data.

If the job data reception unit 807 has received only variable data, the job data processing unit 810 composites the variable data and registered master data. The job data processing unit 810 repetitively uses the master data as common data for a page of variable data. Since no master data is transmitted for each record, the printing efficiency can improve.

In S1304, the image forming apparatus 103 determines whether the composition of all variable data to the form has ended. If the composition of variable data and master data of all pages has not ended (NO in S1304), the process returns to S1303 to repeat the same processing until all variable data are composited. If the composition of all variable data has ended (YES in S1304), the process advances to step S1305, and the image forming unit 811 prints by forming an image.

In S1306, after confirming the end of outputting the variable data print job, the job data control unit 808 of the image forming apparatus 103 deletes the master data from the form data storage unit 809. Then, the process ends.

In the first embodiment, when layout data exists in the master folder, variable data is generated using the layout data. When record data is input to the variable data printing hot folder having undergone printing once, printing starts without creating layout data.

The first embodiment can perform variable printing using the hot folder without the mediacy of a variable printing-specific application.

The first embodiment can perform variable printing by only inputting record data to the hot folder when performing printing again.

By using master data as common data, the first embodiment obviates the need to transmit master data for each record data and can increase the data transfer efficiency.

### Second Embodiment

The first embodiment has described a configuration which executes variable printing by inputting record data to a hot folder corresponding to variable printing.

Variable printing can also be performed by inputting, to the hot folder, data (to be referred to as “record-added master” hereinafter) generated by merging record data and layout-added master data. The second embodiment will explain variable printing executed by inputting a record-added master to the hot folder.

There are two types of record-added masters: one is a compressed record-added master generated by compressing record data and a layout-added master as an archive file; and the other is an attached record-added master generated by attaching record data to a record-added master as one file. The attached record-added master is a file of a format which can undergo normal printing by the hot folder, so whether to process the attached record-added master as variable printing data can be set in advance for the hot folder manager.

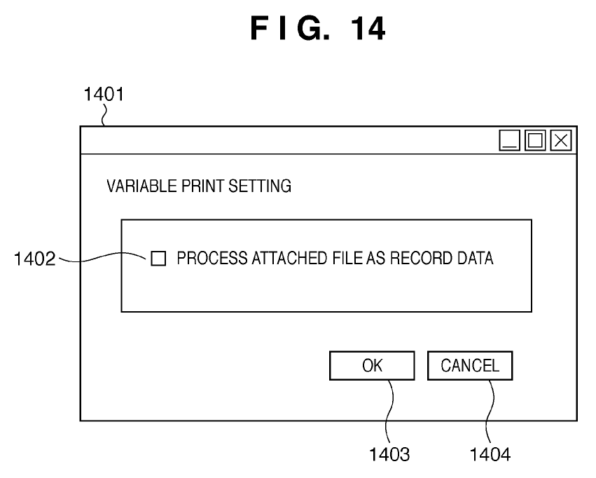

FIG. 14 is a view showing a variable print setting window 1401 of the hot folder manager. The variable print setting window 1401 has a check box 1402, OK button 1403, and cancel (Cancel) button 1404. The check box 1402 is used to set, in the hot folder manager, whether to process data input to the hot folder as variable printing data. When the user checks the check box 1402 and clicks the OK button 1403, it is set to process an attached file as record data. When the user clicks the cancel button 1404, the check box 1402 is unchecked to cancel the setting of the hot folder manager.

When the check box 1402 is checked, for example, it is set to process an attached file as record data. Layout data is created to perform variable printing, similar to the first embodiment. When the check box 1402 is not checked, an attached file is ignored, and normal printing is done.

An attached record-added master is a file of a format which can undergo normal printing by the hot folder. By setting in advance for the hot folder manager to process the attached record-added master as variable printing data, variable printing can be done for the attached record-added master.

For a compressed record-added master, whether to perform variable data printing is determined by analyzing compressed data.

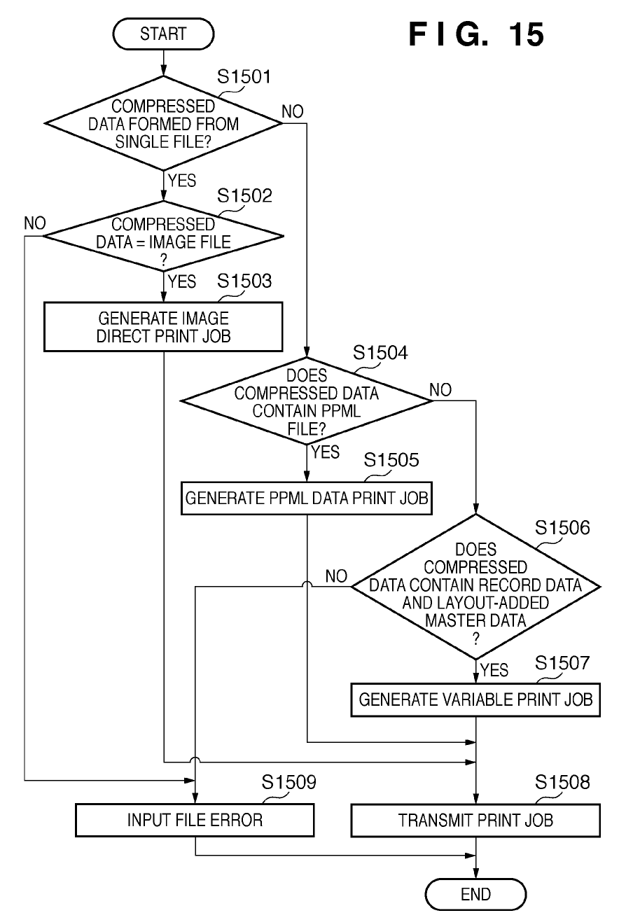

FIG. 15 is a flowchart for explaining the sequence of determination processing for determining whether a compressed record-added master can undergo variable printing. This processing is executable under overall control of the hot folder manager.

In S1501, the hot folder manager determines whether compressed data is formed from a single file. If the compressed data is formed from a single file (YES in S1501), the hot folder manager advances the process to S1502.

In S1502, the hot folder manager determines the attribute of the compressed data. If the compressed data is TIFF image data (YES in S1502), the hot folder manager advances the process to S1503 to generate a print job (image direct print job) for printing image data. In S1508, the hot folder manager transmits the image direct print job.

If the hot folder manager determines in S1502 that the compressed data is not an image file, it determines that the hot folder cannot deal with this file, and then advances the process to S1509 to execute input file error processing.

If the hot folder manager determines in S1501 that the compressed data is formed from a plurality of files (NO in S1501), the hot folder manager advances the process to S1504.

In S1504, the hot folder manager determines whether the compressed data contains a PPML file of the PPML language. If the compressed data contains a PPML file, the hot folder manager advances the process to S1505. The process in S1504 can be done by analyzing data input to the hot folder and determining the presence/absence of PPML designation.

In S1505, the hot folder manager generates a print job (PPML data print job) for printing PPML data, and transmits the generated PPML data print job to the image forming apparatus 103 (S1508).

If the hot folder manager determines in S1504 that the compressed data does not contain a PPML file of the PPML language (NO in S1504), it advances the process to S1506. If the compressed data contains record data and layout-added master data (YES in S1506), the hot folder manager advances the process to S1507. The process in S1506 is done by, for example, determining whether information representing layout-added master data is added to the input data. For example, when creating layout-added master data by using word-processing software or the like, the user sets a subtitle “layout-added master data” of the data using a function of the word-processing software. By analyzing this subtitle, the process in S1506 is executed. Note that “layout-added master data” may also be set by another method.

In S1507, the hot folder manager generates a variable print job on the basis of the record data and layout-added master data by the same processing as that in the first embodiment. In S1508, the hot folder manager transmits the generated variable print job.

If the hot folder manager determines in S1506 that the compressed data does not contain record data and layout-added master data (NO in S1506), it advances the process to S1509. The hot folder manager determines that the hot folder cannot deal with this file, and executes input file error processing.

The second embodiment can perform variable printing using the hot folder without the mediacy of a variable printing-specific application.

The second embodiment can perform variable printing by only inputting record data to the hot folder when performing printing again.

By using master data as common data, the second embodiment obviates the need to transmit master data for each record data and can increase the data transfer efficiency.

### Other Embodiments

The object of the present invention is also achieved by supplying a computer-readable storage medium which stores the program codes of software (computer program) for implementing the functions of the above-described embodiments to a system or apparatus. The object of the present invention is also achieved by reading out and executing the program codes stored in the storage medium by the computer (or the CPU or MPU) of the system or apparatus.

In this case, the program codes read out from the storage medium implement the functions of the above-described embodiments, and the storage medium which stores the program codes constitutes the present invention.

The storage medium for supplying the program codes includes a flexible disk, hard disk, optical disk, magnetooptical disk, CD-ROM, CD-R, nonvolatile memory card, and ROM.

The functions of the above-described embodiments are implemented when the computer executes the readout program codes. Also, the present invention includes a case where an OS (Operating System) or the like running on the computer performs part or all of actual processing based on the instructions of the program codes and thereby implements the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-154437, filed Jun. 11, 2007, which is hereby incorporated by reference herein in its entirety.

What is claimed is:

1. An information processing apparatus capable of communicating with an image forming apparatus capable of form overlay printing, the information processing apparatus comprising:
a layout unit adapted to lay out content data contained in record data in form data used in the form overlay printing;
a specifying unit adapted to specify an item of a database to which each content data laid out in the form data by said layout unit belongs;
a layout data generation unit adapted to generate layout data associated with layout of content data so as to lay out, at a position of content data of laid-out record data, content data of another record data belonging to the same item as an item of the content data of the laid-out record data by using a specified result of said specifying unit;
a variable data generation unit adapted to generate variable data for rendering the content data of said another record data in the form data on the basis of the layout data; and
a transmission unit adapted to transmit a print job containing the form data and the variable data to the image forming apparatus.

2. The apparatus according to claim 1, wherein
when form data in which the content data is laid out is input to a storage area where print setting information used in printing is set, said transmission unit holds the form data without transmitting the form data to the image forming apparatus,
when record data containing the content data is input to the storage area, said variable data generation unit generates the variable data by using the layout data and the record data, and
said transmission unit transmits, to the image forming apparatus, the generated variable data and the form data from which the content data is excluded.

3. The apparatus according to claim 1, wherein when data input to a storage area where print setting information used in printing is set includes record data and form data in which content data of specific record data is laid out, said variable data generation unit generates variable data by using the record data and the layout data.

4. The apparatus according to claim 1, wherein said layout data generation unit generates the layout data on the basis of position information of content data laid out in the form data and attribute information of the content data.

5. An information processing method in an information processing apparatus capable of communicating with an image forming apparatus capable of form overlay printing, the method comprising:
a layout step of causing a layout unit to lay out content data contained in record data in form data used in the form overlay printing;
a specifying step of causing a specifying unit to specify an item of a database to which each content data laid out in the form data in the layout step belongs;
a layout data generation step of causing a layout data generation unit to generate layout data associated with layout of content data so as to lay out, at a position of content data of laid-out record data, content data of another record data belonging to the same item as an item of the content data of the laid-out record data by using a specified result of the specifying step;
a variable data generation step of causing a variable data generation unit to generate variable data for rendering the content data of said another record data in the form data on the basis of the layout data; and
a transmission step of causing a transmission unit to transmit a print job containing the form data and the variable data to the image forming apparatus.

6. The method according to claim 5, wherein
in the transmission step, when form data in which the content data is laid out is input to a storage area where print setting information used in printing is set, the form data is held without transmitting the form data to the image forming apparatus,
in the variable data generation step, when record data containing the content data is input to the storage area, the variable data is generated by using the layout data and the record data, and
in the transmission step, the generated variable data and the form data from which the content data is excluded are transmitted to the image forming apparatus.

7. The method according to claim 5, wherein in the variable data generation step, when data input to a storage area where print setting information used in printing is set includes record data and form data in which content data of specific record data is laid out, variable data is generated by using the record data and the layout data.

8. The method according to claim 5, wherein in the layout data generation step, the layout data is generated based on position information of content data laid out in the form data and attribute information of the content data.

9. A computer program which is stored in a storage medium readable by an information processing apparatus and causes an information processing apparatus capable of communicating with an image forming apparatus capable of form overlay printing to execute an information processing method, the information processing method comprising:
a layout step of causing a layout unit to lay out content data contained in record data in form data used in the form overlay printing;
a specifying step of causing a specifying unit to specify an item of a database to which each content data laid out in the form data in the layout step belongs;
a layout data generation step of causing a layout data generation unit to generate layout data associated with layout of content data so as to lay out, at a position of content data of laid-out record data, content data of another record data belonging to the same item as an item of the content data of the laid-out record data by using a specified result of the specifying step;
a variable data generation step of causing a variable data generation unit to generate variable data for rendering the content data of said another record data in the form data on the basis of the layout data; and
a transmission step of causing a transmission unit to transmit a print job containing the form data and the variable data to the image forming apparatus.

10. The program according to claim 9, wherein
in the transmission step, when form data in which the content data is laid out is input to a storage area where print setting information used in printing is set, the form data is held without transmitting the form data to the image forming apparatus,
in the variable data generation step, when record data containing the content data is input to the storage area, the variable data is generated by using the layout data and the record data, and
in the transmission step, the generated variable data and the form data from which the content data is excluded are transmitted to the image forming apparatus.

11. The program according to claim 9, wherein in the variable data generation step, when data input to a storage area where print setting information used in printing is set includes record data and form data in which content data of specific record data is laid out, variable data is generated by using the record data and the layout data.

12. The program according to claim 9, wherein in the layout data generation step, the layout data is generated based on position information of content data laid out in the form data and attribute information of the content data.

13. An image forming system comprising an information processing apparatus capable of generating a print job interpretable by an image forming apparatus, and an image forming apparatus capable of form overlay printing on the basis of the print job,
said information processing apparatus comprising:
a layout unit adapted to lay out content data contained in record data in form data used in the form overlay printing;
a specifying unit adapted to specify an item of a database to which each content data laid out in the form data by said layout unit belongs;
a layout data generation unit adapted to generate layout data associated with layout of content data so as to lay out, at a position of content data of laid-out record data, content data of another record data belonging to the same item as an item of the content data of the laid-out record data by using a specified result of said specifying unit;
a variable data generation unit adapted to generate variable data for rendering the content data of said another record data in the form data on the basis of the layout data; and
a transmission unit adapted to transmit a print job containing the form data and the variable data to said image forming apparatus, and
said image forming apparatus comprising:
a reception unit adapted to receive the form data and the variable data which are transmitted from said information processing apparatus;
a job data control unit adapted to register the form data;
a composition unit adapted to composite the variable data and the form data; and
an image forming unit adapted to execute image forming processing on the basis of the form data and the variable data which are composited by said composition unit.
